(19) United States
(12) Patent Application Publication
(10) Pub. No.: US 2007/0297400 A1
(43) Pub. Date: Dec. 27, 2007

(54) Port redirector for network communication stack

(76) Inventors: Allan Cameron, Saint John (CA); Shalom Wertsberger, South Portland, ME (US)

Correspondence Address: SALTAMAR INNOVATIONS, 30 FERN LANE, SOUTH PORTLAND, ME, 04106, US

(21) Appl. No.: 11/426,372

(22) Filed: Jun. 26, 2006

(51) Int. Cl. H04L 12/56

(52) U.S. Cl. 370/389

(57) ABSTRACT

A controllable port redirector comprising a stack module insertable within a communication protocol stack, preferably between the data-link and the network layer. The redirector uses a rule base, at least partially downloaded from a control host, to decide on redirection of selected packets. The invention further provides a method for communication using at least partial remotely supplied rule base. Thus communications from the computer may be remotely and transparently controlled. Optionally the invention further provide a method for providing secured communication utilizing port hopping technique, controlled by a rule set which forms a hoping order, and utilizing different rules of packets from the same transmission stream, thus increasing the difficulty in monitoring the stream as a whole. Other services that may be established by the invention include replacing certain servers like DNS servers, providing a walled garden communication environment, and the like.

### FIELD OF THE INVENTION

The present invention relates generally to data communications, and more particularly to controllably redirecting communications.

### BACKGROUND OF THE INVENTION

Data networks often use a combination of layers to achieve communications between network devices. A common model for communication layers is provided in the International Standard Organization Open System Interconnect (ISO-OSI) model and Transfer Control Protocol/Internet Protocol (TCP/IP). Those layers are commonly known as ‘communication stack’, ‘protocol stack’, or simply ‘stack’ as data packets traverse several of those layers in order. Thus, by way of example, in the ISO-OSI model layer 1 represents the physical layer which specify low level details such as cable and connector type. The data link layer 2 deals with the like of immediate address, checksum generation and checking, and the like. Layer 3, or the network layer deals with the like of routing, physical addressing, breaking up large packets into small ones and reassembly of such packets and the like. Layer 4 is transport layer which provides complete transport services between two network hosts. By way of example, in TCP/IP networks this layer comprises both the Unreliable Datagram Protocol (UDP) and the Transfer Control Protocol (TCP). This layer appears to the layers above it as a high level inter-host link which appears as an address:port combination. The layers on top of the transport layer provide higher level communication functions and are known as the session, presentation, and application layers.

Numerous protocols have been developed to provide additional functionality to those provided by generic network model. Perhaps the most common is the various secured transport protocols such as Virtual Private Networks (VPN), or Secured Socket Layer (SSL) which provides a higher level of security than that provided by the generic model. VPN networks allow for secure communications from a network host like a Personal Computer (PC) to another host or a complete network, over public, generally not-secured, communication channels. A common example for VPN link is the connection of a PC to a remote and secure intranet via the internet, hopefully in away that appears transparent to the PC user. However certain applications limit usage of specific protocols or transport methods other than those dictated by their own design. In most cases those applications are so successful that despite there incompatibility with certain environments, they are still needed for the services they provide. One example of such a program is the highly successful program Microsoft Exchange (trademark of Microsoft Corp, Redmond, Wash., USA), which does not easily lends itself to the use of certain protocols. There is therefore a need for a solution to allow the integration of such applications in an environment that utilizes communications that do not follow the dictates of such applications.

Certain communication protocols are non routable. Older protocols that were designed for Local Area Network (LAN) use only without considerations to the internet, are an excellent example however other protocols are designed specifically to stay within a certain local environments. An example of such protocol is the Address Resolution Protocol (ARP), which is specifically designed to stay within the confines of its LAN. However in certain cases, and especially in the case of VPN networks, an ARP routed to the target intranet may provide an easy discovery within the intranet, which will provide significant advantages. Therefore, there is a need to provide a method for routing non-routable protocols.

While specific solutions to those problems exist, they are implemented in a manner which requires high level of user intervention and sophistication. They require installation, configuration, updating, and management. Therefore, there is a need for a system that will offer simple and easy installation of software or hardware to perform those tasks. Preferably, such solution should be manageable by a remote station so that professional configuration, updates, and the like, may be effected without bothering the user.

Moreover, as different applications provide different and often incompatible demands on the communication capacity, there is a need for easily modifying the configurations those applications perceives to be operating in. Therefore there is a need for a solution that will allow traffic from specific applications to be handled in accordance with application specific rules.

While VPN or similar secured protocols are generally considered as highly secured, a dedicated intruder may monitor, collect and eventually decode communication contents of even a secure link. However if the port selection of such link keeps changing, unauthorized interception of the transmission becomes much harder.

Different aspects of the present invention are directed to solving one or more of the above identified problem, alone or in combination.

### SUMMARY OF THE INVENTION

Therefore, the present invention provides a port redirector module, embedded in software, hardware, or a combination thereof, that provides the capacity to redirect communications transparently to the applications or even to most of the operating system using it, while its operation is being controlled by a remote host. Preferably the redirector is embedded in the communications protocol stack.

Thus in one aspect of the invention there is provided a personal computer controllable port redirector comprising a stack module insertable within a communication protocol stack. The stack module is being constructed to receive and send packets to at least one upstream protocol module and at least one downstream protocol module, at least one of said packets having a packet target address associated therewith. A rule base comprising at least one rule having a rule criteria and a rule destination address is provided, as is a control module for causing the stack module to, when a packet meets the criteria of at least one rule, change the packet target address with the rule destination address, and wherein at least one rule is downloaded from a control server upon activation of the redirector.

It should be noted that in these specifications, the term should be construed as the destination of a packet, and thus by way of example, may be an address, a port, an address:port combination, or any range or ranges thereof.

Preferably the port redirector comprises a logging module. In the preferable embodiment, the communication protocol stack is a TCP/IP stack, and the stack module is inserted between the network layer and the data link layer of the communication protocol stack.

Optionally, the redirector is configured according to a user profile. Most preferably the user profile is stored at the control server, which selects configuration parameters in accordance with the profile, and sends these parameters to the redirector. Most preferably the control server authenticates the user, and sends to the redirector a software certificate effective to authenticate the user with at least one target server. By doing so a single system-wide login is affected for logging into and authenticating users between dispersed servers. Optionally in this most preferred embodiment, the target server is in communication with said remote server, and can authenticate the certificate, but in some embodiments this may not be needed and the target server will just use stored information regarding the certificate. The control server may construct software for at least a portion of the port redirector in accordance to user profile, and send the software to the computer for execution thereupon.

In a related aspect of the present invention, there is provided a method for controlling communications utilizing a port redirector in a computer. The computer having a communication protocol stack which receives and sends packets, the packets having at least a packet target address associated therewith. The method comprising the steps of:
installing a stack module in the protocol stack;
downloading from a control server at least one rule into a rule base, the rule having at least a rule criteria and a rule destination address;
comparing at least one packet transferred through the stack module to rules in the rule base, and if the packet matches the rule criteria, replacing the packet target address with an address obtained from the rule.

Preferably, the method further comprises the step of configuring the port redirector according to a user profile, most preferably stored in the control server. The most preferred method further comprises the step of authenticating the user in the control server, and sending a software certificate to the redirector, so it may be used for user authentication to at least one target server.

In yet another aspect of the present invention there is provided a method for port redirection as described above, but with the added advantage of providing secured, scrambled communication link between the computer and any other computer. This is obtained by further performing the steps of:
establishing a hoping order comprising a plurality of interconnected rules; and,
activating different rules of said plurality in accordance with trigger events, to affect scrambling communication of a data stream by using different rules on at least two packets from the data stream, corresponding to the hoping order.

The trigger event may be time, traffic volume, signal from a target host, signal from said control server, a combination thereof, and the like. The hoping order may be stored in the rule base, received from the control server or the target host, and the like. If desired, a plurality of hoping orders may be stored in the rule base.

It is clear therefore that by using selected aspects of the invention, the user may achieve the tangible results of selective redirecting of communications, and more preferably remotely selective redirecting of communications, either for setting an operating environment, for enhancing data communications security, for enhancing system security, or for any combination thereof, in addition to other aspects and benefits of the invention.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a general outline of a setting incorporating the preferred embodiment of the invention

FIG. 2 depicts a simplified block diagram of a port redirector according to the preferred embodiment

FIG. 3 is a simplified flow diagram depicting the operation of the port redirector according to the preferred embodiment

FIG. 4 is a system flow diagram within the preferred embodiment of installation of and initialization of a port director.

FIG. 5 is a system flow diagram of communication operation without redirection.

FIG. 6 is a system flow diagram of communication operation with a redirection.

FIG. 7 is depicts examples of redirection rules.

FIG. 8 is a simplified flow diagram for port hoping communication method utilizing the preferred embodiment.

### DETAILED DESCRIPTION

For convenience, the following examples will assume a TCP/IP based protocol, but the skilled in the art will easily recognize that any communications protocol and protocol stacks may be utilized. Similarly, the following examples of embodiments, communication protocols, devices, and methods, software modules organization, and boundaries, and the like are provided only by way of non-limiting examples. Modifications thereof will be clear to the skilled in the art and fall within the scope of the invention and the appended claims.

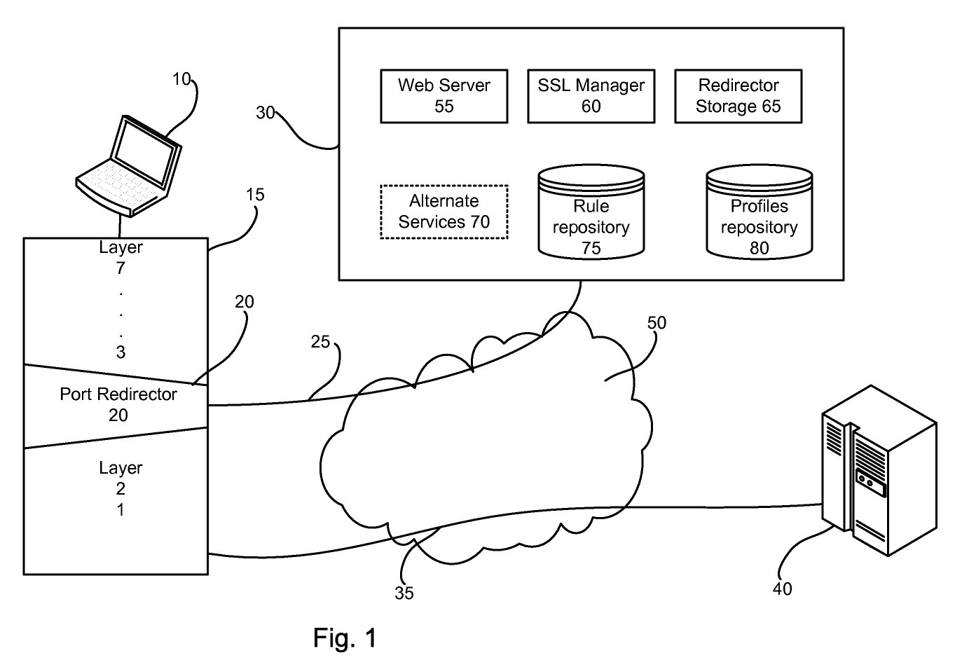

The reader is now directed to the accompanied drawings which depict different aspects and preferred embodiments of the present invention. Referring now to FIG. 1, a PC 10 having a communication stack 15 is shown. The port redirector 20 is preferably implemented as a software module, but any combination of software or hardware may be used. The port redirector is shown to be ‘wedged’, i.e. inserted between, layers 2 and 3. As stated above, layer 3 is the network layer and layer 2 is the data link layer. Thus any activity performed by port redirector 20 will likely be transparent to most if not all of the applications executed on the computer, and to large parts of the operating system as well. It is noted however that for the sake of clarity, the communications protocol stack 15 is shown outside the PC while the skilled person will understand that in most cases, it is implemented within the PC as a group of intercommunicating software modules.

The port redirector can communicate with a control server 30 via control link 25. Communications between the server and the redirector are preferably implemented as a secured link such as SSL. The control link 25 preferably utilizes the internet 50 as its physical medium, but the SSL provides it with the required security. Alternatively, the control link may be any data capable link other than the Internet, such as a telephone link, a cellular link, a dedicated data circuit, and the like. Target host 40 generally represents in a schematic manner any target computer, network, or network node, such as, by non limiting example, a target intranet, a router, a database server, a storage server, and application server, and the like. Communication to target host 40 occurs via data link 35.

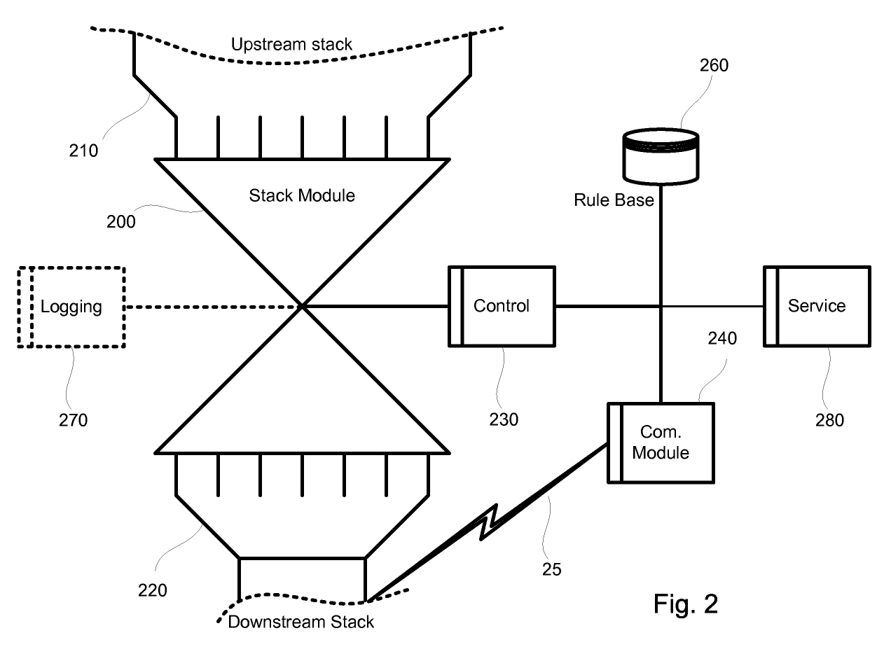

The port redirector is depicted in a simplified block diagram in FIG. 2. The upstream data flow 210 is a connection to the upper layers of the communications stack, while the downstream data flow to the lower layers of the communication stack is represented by 220. The module in which data packets are received, and from which they are sent is depicted schematically by stack module 200. Redirection controller utilizes local copy of redirection rules in rule base 260 for controlling data packet redirection in the stack module 200. Service module 280 controls aspects of operation such as port redirector configuration, authentication, upgrades, and other and optionally logged in logging module 270, while communications module 240 provides communications between the port redirector 20 and the control server 30. While the rule base may contain fixed rules, downloaded rules that are downloaded at desired intervals or responsive to desired events, in some cases, the local rule base may be wholly or partially updated dynamically during operation. This allows for highly secured communications in one preferred embodiment of the invention. It is noted that while control link 25 is shown using the downstream stack layers. This is but the preferred embodiment. However control link 25 may utilize dedicated communication path, or share a communication path with other services separate from the IP stack as shown. The implementations of such embodiments are a matter of technical choice and will be clear to the skilled in the art.

FIG. 2 further shows an optional logging module 270 for logging communications activities. Such logs may be operative selectively, and in one preferred embodiment, the control server may request delivery of the logged data.

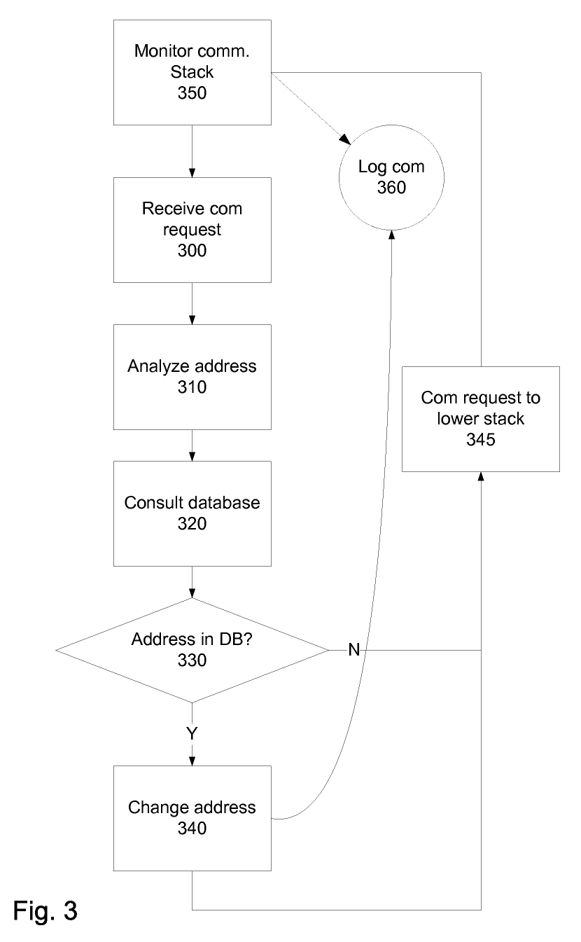

FIG. 3 depicts a simplified flow diagram of the preferred embodiment of a port redirector. The diagram is directed to data sent from the application to a remote host, but the skilled will clearly see that the operation is very similar to data coming from a remote host to the communication stack.

The stack module 200 monitors 350 all communications from the upper communication stack 15 layers to the lower communication stack layers, and vice versa. Upon receiving a communication request 300, the stack module 200 analyzes the destination and/or source address data, and transfers the address information to control module 230. Control module 230 searches the rule base for the address or a portion thereof. If the rule base has a rule for the address, (option Y of query 330) the stack module changes the packet address 340 and forwards the packet to the lower stack 345. If no rule for the address is found, step 340 is skipped and the data is forwarded to the lower stack unchanged. Having its main function achieved, the port redirector continues to monitor the incoming and outgoing network traffic 350. Optionally data may be collected from any desired module and logged 360 in logging module 270. Clearly, similar operation may be performed for traffic incoming to the computer with the difference being primarily that the data is transferred from the lower stack layers to the upper stack layers.

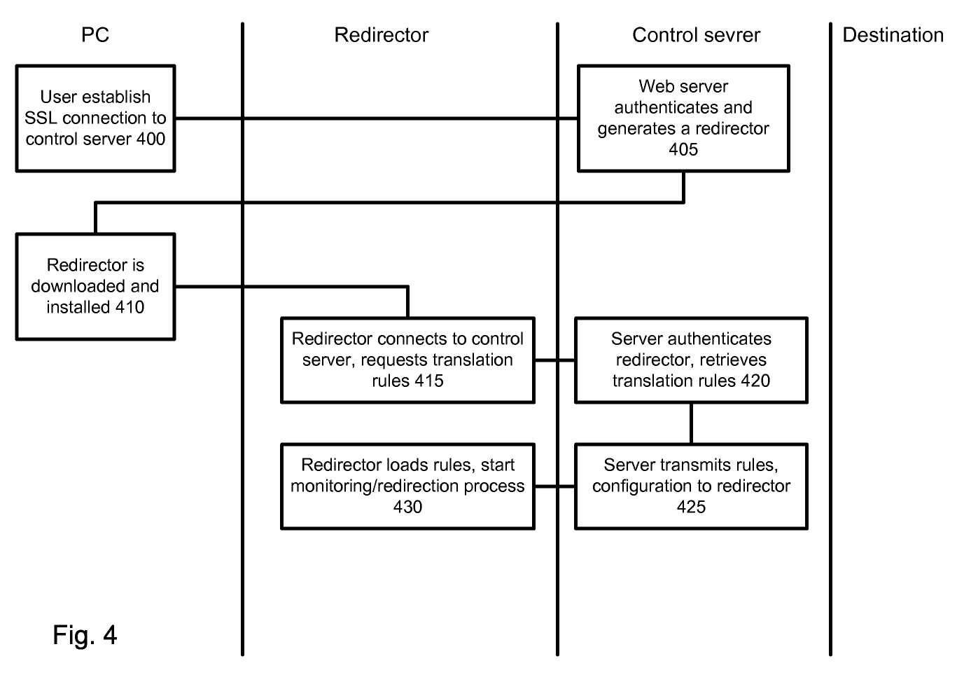

FIG. 4 is a simplified flow diagram of the process of installation and initialization of the preferred embodiment of the port redirector. First, it is assumed that either the port redirector has never been installed on the PC 10 or that the system designer elected to reinstall the redirector for every time controlled communications is desired. Thus, in step 400 the user establishes a connection from the PC 10 to control server 30. Preferably the connection utilizes a secure link such as SSL. Alternatively these steps may be carried within a secured environment such as within the confines of a company internal environment. The preferred embodiment calls for the user to communicate in a common manner with the web server component 55 of control server 30. The skilled in the art will recognize that the different functions of server 30 may be in a single server or may be distributed.

The web server authenticates the user using SSL manager 60, and generates a port redirector for the user 405. The generation of the port redirector may be as simple as utilizing a single redirector module for all users, or may be as elaborate of dynamically generating code according to data stored in profile repository 80. The port redirector, different portions of the redirector code, and/or rules for generating redirector code on the fly may be stored in redirector storage 65. The port redirector 20 code is then sent to the PC.

Once the redirector code has been downloaded, it is installed 410 in the communication stack. Preferably the redirector is installed between layers 2 and 3, but other locations within the stack may be implemented.

This installation process may occur only once, it may occur periodically as needed to update the port redirector, or it may occur whenever the user tries to establish secured communication within a system utilizing one or more aspects of the invention. The selection of the installation timing and method is a matter of technical choice.

Once the redirector is installed it is initialized. As part of the initialization process service module communicates 415 to control server 30 via control module 240 and control link 25, and requests a fresh copy of redirection rules. In step 420 control server 30 identifies the user using the SSL manager 60, or a similar secure protocol. Once the user is identified and authenticated, the server retrieves the translation rules from rule repository 75. The rules may be general rules or rules specific to a user.

The initialization stage is an excellent opportunity to configure the port redirector, check for upgrades, and the like. Rules, and optionally configuration parameters, are transmitted to the port redirector 425. If a complete or partial upgrade is required the service module 280 handles most of those tasks. Rules are loaded to the local rule base 430 and the port redirector is ready to monitor and redirect traffic. In the most preferred embodiment the steps of retrieving the rules occurs at least once for every session, and in some cases they also happen periodically to verify currency. In less desirable embodiment, the rules may be dynamically obtained from the server, but doing so may slow down response time. However such embodiment will offer an extremely secured communications.

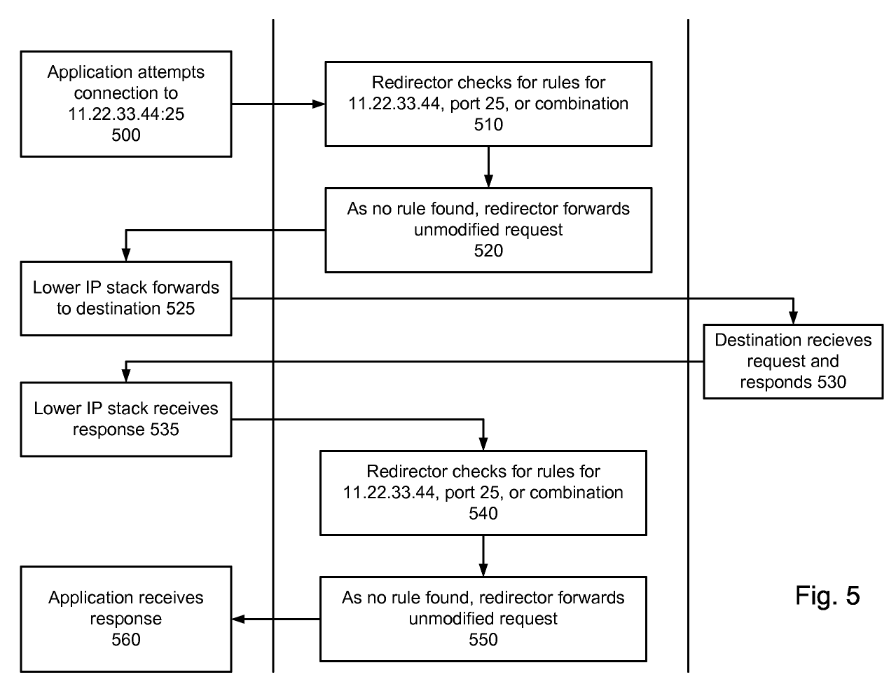

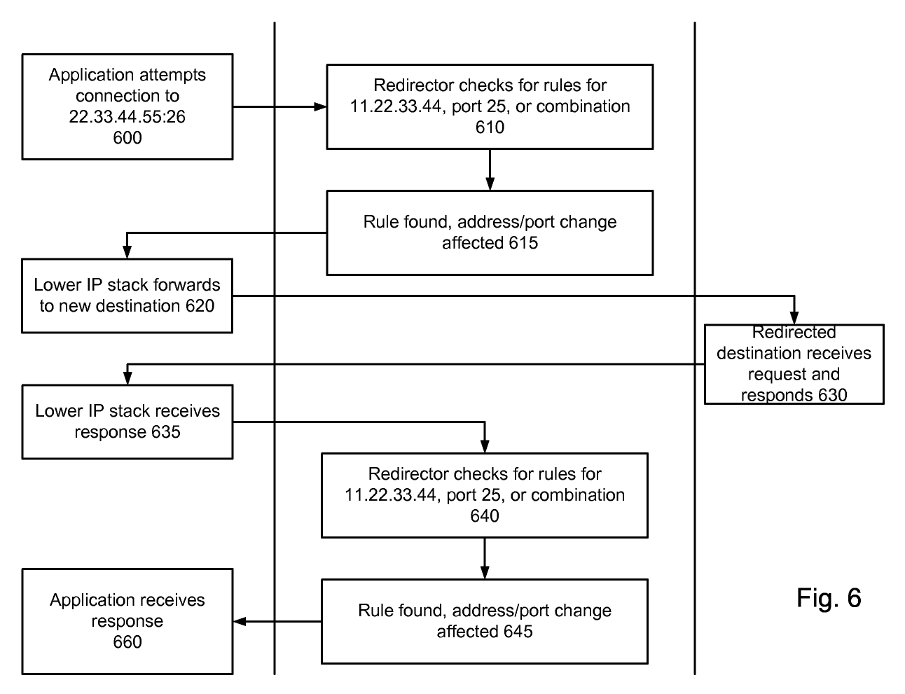

Once installed and configured, the port redirector may begin operating substantially as described regarding FIGS. 5 and 6.

FIG. 5 depicts an example of a typical flow diagram of communications without redirection. In step 500 an application attempts to connect to an address, which for this example is 11.22.33.44, at port 25. The communication request arrives via the upstream stack 22 to stack module 200. The packet is analyzed to extract the address or a part thereof, and the rule base 260 is checked 510 to see if there is a rule directed to that address. As no rule is found, 520, the redirector control 230 instructs the stack module 200 to transfer the packet with unmodified address to downstream stack 220, from which is transmitted to the destination 525. Once the destination node responds 530 the lower stack receives the response 535 and transfers it to redirector 20. Again, the stack module analyzes the source address and the control module checks against the rule base. Since in this example no rule is found, the packet is transferred 550 to the upper stacks, and the application receives 550 its response. It should be noted that the packet target address in this case is internal address, rather than relating to a remote server, however the operation is similar, and for simplicity the term target address should be construed according to the destination of the packet.

Similarly, for brevity most of these specifications and claims were constructed to read on a target address being the key criteria to a packet matching the rules. However the skilled in the art will recognize that the selection of the rule as a matching rule may occur based varied criteria. By way of non limiting example, the rule criteria may comprise of the source address of the packet, a protocol type, a range of addresses, transmission time, state of the software initiating the communications, state of the port redirector or any component thereof, state of the packet target, state of the remote server, and the like. and the specifications and the claims should be construed to extend to such an embodiment.

FIG. 6 operates similarly to FIG. 5 but in this example, after the application attempts to send a packet 600 to the specific address:port combination, the check for rule 610 detects a rule for this specific address 615.

It is important to note that the rule may be directed to an address, and address range, to a specific port or port ranges within the address:port combination, or to specific ports at any host. Doing so allows for example capturing and redirecting certain services to a safe controlled environment.

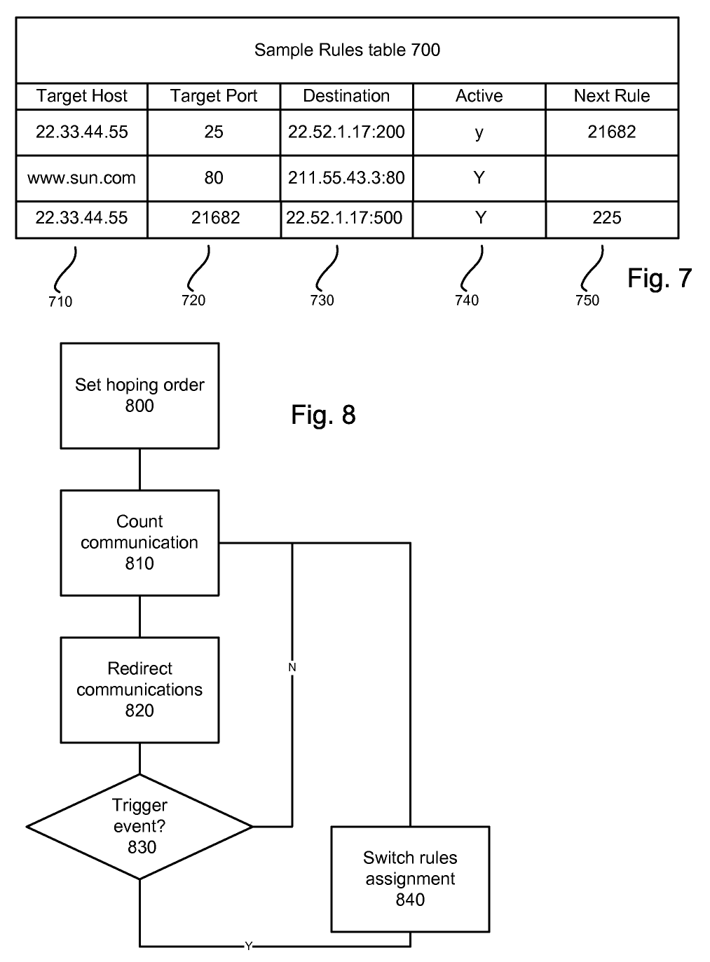

Once the rule is found the redirector modifies the address, and/or takes any other desired action on the packet as instructed by the rule. An example of simple rules 700 is shown in FIG. 7. A rule may contain a target host address 710 and port 720, a destination address 730 to which a packet originally directed to the host address:port combination is being directed, and an indication if the port is active 740. In some embodiments the indication 740 is not implemented.

Thus in the example once a match is found between the target address 22.33.44.55:26 and the rule, the packet will be redirected to 127.0.0.1:25677. The packet is transferred to the lower stack 620 which forwards it to the redirected destination. Redirected destination may not be aware that the package was redirected. However the redirected destination sends a response 630, which is received 635 by the lower IP stack. The lower IP stack transfers the packet to the redirector and again if a relevant rule is found 640 changes are affected according to the destination port, or the source address. After the changes are affected 645 the response packet is transferred to the application 660.

In certain preferred embodiments both the destination and the source addresses are being analyzed. Doing so allows controlling application behavior, such as limiting access to specific ports or destinations by specific applications, users, and the like.

FIG. 8 depicts simplified flow diagram for one embodiment of a scrambled communication method utilizing the port redirector. In this embodiment, the first rule in table 700 includes a ‘next rule’ pointer field 750. The scrambled communications system begins by sending a group of rules that are constructed as an order—one rule leads to the next which in turn leads to the next one, and so on. A plurality of such hoping orders may be set within a single rule base. Thus the device first selects a hoping order 800. The hoping order may be hard coded, selected by an application, or set manually or remotely. Once the hoping order is selected, communications begin. The communication packets are redirected 820 to the target host as described above.

During communications the port redirector continually monitors for a trigger event 830. A trigger event may occur due to many reasons, that are a matter of technical choice. Examples of trigger events include but are not limited to reaching a certain communication volume such as number of bytes sent and/or received, a preset time has elapsed, a code arrives in the communications content, a manual user intervention, or, in the most preferred embodiment, the reception of a command from the control server, for example generated by the alternate services module 70, that is transmitted via control link 25. In response to such trigger event the port redirector utilizes the ‘next port’ field 750 to redirect the future communication to. Thus in the example illustrated, communications directed to 22.33.44.55:25 are initially directed to 22.52.1.17:200. Once a trigger event occurs 830 the redirector utilizes the ‘next rule’ field 750 to select a new redirection rule. This can be carried out by changing the rule in the rule base, by doing multiple redirections, by a rules index, and other common programming methods that will be clear to the skilled in the art. Thus after the rule assignment switch 840 the next traffic to the 22.33.44.55:25 packet will be directed to 22.52.1.17:500. It is noted that by using a ‘next port’ number in the pointer field will result in equivalent behavior to ‘next rule’ and thus such example embodiment is considered to be covered by the ‘next rule’ example.

Such port hoping or even address hoping provides an extremely useful method for secure communications, as the monitoring of all ports is of limited use, especially in real time, and the sending application is completely unaware of the address:port assignment changes and thus requires no change.

In the most preferred embodiment, the trigger event is generated by the alternate services module 70 of the control server, which dictates not only the timing of the redirection switch but also the address:port for the next packet redirection. The skilled in the art will recognize that while this system is not shown in the drawing it is very easily understood, and thus a drawing will not add to the understanding of the invention. The simplest example of such embodiment is simply when the control server 30 sends a command to the port redirector 20 to redirect all future packets that the application sends to one address to another address:port combination. Most preferably, such command is sent by the secured control link 25. Also preferably, the control server notifies both the sender redirector and the receiver redirector.

The invention may clearly facilitate secured communications using any desired protocol or protocol group such as TCP, UDP, and the like. It is further important to note that different aspects or portions of the invention may be embodied in hardware form, software form, or a combination thereof. By way of example the invention may easily be implemented within a communication hardware that deals with the protocol stack using specialized hardware, and the like. Thus the invention extends to any computing device or system using the methods of communication redirection and/or other aspects of the invention.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. A personal computer controllable port redirector comprising:
a stack module insertable within a communication protocol stack, said stack module being constructed to receive and send packets to at least one upstream protocol module and at least one downstream protocol module, at least one of said packets having a packet target address associated therewith;
a rule base comprising at least one rule having a rule criteria and a rule destination address;
a control module for causing said stack module to, when a packet meets the criteria of said at least one rule, change said packet target address with said rule destination address; and,
wherein said at least one rule is downloaded from a control server upon activation of said redirector.

2. A port redirector as claimed in claim 1 further comprising a logging module.

3. A port redirector as claimed in claim 1 wherein said communication protocol stack is a TCP stack.

4. A port redirector as claimed in claim 1 wherein said stack module is inserted between the network layer and the data link layer of said communication protocol stack.

5. A port redirector as claimed in claim 1, wherein at least a portion of said redirector is downloaded from said control server upon a communication attempt from said personal computer.

6. A port redirector as claimed in claim 1, further comprising a communication module which is in communication with said control server and constructed to modify or replace at least one rule of said rule base during redirector operation.

7. A port redirector as claimed in claim 1, wherein said control server and said computer communicate via an encrypted link.

8. A port redirector as claimed in claim 1 wherein said control server and said computer are linked via a data link separate from said communication protocol stack.

9. A port redirector as claimed in claim 1 further comprising a service module constructed to configure said port redirector, responsive to instructions received from said control server.

10. A port redirector as claimed in claim 1 further comprising a service module adapted to upgrade at least one component of said port redirector, responsive to instructions from said control server.

11. A port redirector as claimed in claim 1 wherein said redirector or a portion thereof are installable by a visit to an internet web site.

12. A port redirector as claimed in claim 1 wherein said redirector is configured according to a user profile.

13. A port redirector as claimed in claim 12, wherein said user profile is stored at said control server and wherein said control server selects configuration parameters in accordance with said profile and sends said parameters to said redirector.

14. A port redirector as claimed in claim 12, wherein said control server authenticates said user, and sends to said redirector with a software certificate effective to authenticate the user with at least one target server.

15. A port redirector as claimed in claim 14 wherein said target server is in communication with said control server.

16. The port redirector as claimed in claim 1, wherein said control server constructs software for at least a portion of said port redirector, said software being constructed in accordance to user profile, and sends said software to said computer for execution thereupon.

17. The port redirector of claim 1 wherein said rule criteria comprises at least one range of addresses.

18. A method for controlling communications utilizing a port redirector in a computer having a communication protocol stack which receives and sends packets, said packets having at least a packet target address associated therewith, the method comprising the steps of:
installing a stack module in said protocol stack;
downloading from a control server at least one rule into a rule base, said rule having at least a rule criteria and a rule destination address;
comparing at least one packet transferred through said stack module to rules in said rule base, and if the packet matches the rule criteria, replacing said packet target address with an address obtained from said rule.

19. A method for port redirection as claimed in claim 18, further comprising the step of logging at least a portion of the communication activities facilitated by said stack module.

20. A method for port redirection as claimed in claim 18, wherein said communication protocol stack is a TCP/IP stack.

21. A method for port redirection as claimed in claim 18, wherein said stack module is inserted between the network layer and the data link layer of said communication protocol stack.

22. A method for port redirection as claimed in claim 18, further comprising the step of downloading at least a portion of said port redirector from said control server upon a communication attempt from said computer.

23. A method for port redirection as claimed in claim 18, further comprising the step of communicating with said control server and modifying or replacing at least one rule of said rule base during said port redirector operation, responsive to instructions received from said control server.

24. A method for port redirection as claimed in claim 18, wherein said control server and said computer communicate via an encrypted link.

25. A method for port redirection as claimed in claim 18, wherein said control server and said personal computer are linked via a data link separate from said communication protocol stack.

26. A method for port redirection as claimed in claim 18, further comprising the step of configuring said port redirector, responsive to instructions received from said control server.

27. A method for port redirection as claimed in claim 18, further comprising the step of upgrading at least one component of said port redirector, responsive to instructions from said control server.

28. A method for port redirection as claimed in claim 18, wherein said redirector or a portion thereof are installable by a visit to an internet web site.

29. A method for port redirection as claimed in claim 18, further comprising the step of configuring said port redirector according to a user profile.

30. A method for port redirection as claimed in claim 29, wherein said user profile is stored at said control server and further comprising the steps of, at said control server, selecting configuration parameters in accordance with said profile; and sending said parameters to said redirector.

31. A method for port redirection as claimed in claim 29, further comprising the step of authenticating said user in said control server, and sending a software certificate to said redirector, said software certificate to be used for user authentication to at least one target server.

32. A method for port redirection as claimed in claim 31, wherein said target server is in communication with said control server.

33. A method for port redirection as claimed in claim 18, further comprising the steps of, at said control server, constructing software for at least a portion of said port redirector according to a user profile, and sending said software to said computer for execution thereupon.

34. A method for port redirection as claimed in claim 18, wherein said rule criteria comprises at least one range of addresses.

35. A method for port redirection as claimed in claim 18, further comprising the steps of:
establishing a hoping order comprising a plurality of interconnected rules; and,
activating different rules of said plurality in accordance with trigger events, to affect scrambling communication of a data stream by using different rules on at least two packets from said data stream, corresponding to said hoping order.

36. A method for port redirection as claimed in claim 35, wherein the trigger event is select from a group consisting of time, traffic volume, signal from a target host, signal from said control server.

37. A method for port redirection as claimed in claim 35, wherein said hoping order is stored in said rule base.

38. A method for port redirection as claimed in claim 35, wherein said hoping order is delivered from said target host.

39. A method for port redirection as claimed in claim 35, wherein said hoping order is selected from a plurality of hoping orders stored in said rule base.
